(19) United States
(12) Patent Application Publication
(10) Pub. No.: US 2023/0313967 A1
(43) Pub. Date: Oct. 5, 2023

(54) LAMPSHADE AND LAMP

(71) Applicant: LING LI, YIYANG (CN)

(72) Inventor: LING LI, YIYANG (CN)

(21) Appl. No.: 18/128,349

(22) Filed: Mar. 30, 2023

(30) Foreign Application Priority Data
Mar. 30, 2022 (CN) 202210334486.7

(51) Int. Cl. F21V 1/02; F21V 1/14; F21V 19/00

(52) U.S. Cl. CPC F21V 1/02; F21V 1/14; F21V 19/003; F21Y 2115/10

(57) ABSTRACT

A lampshade and a lamp includes a lampshade substrate, cold light filaments, and a lampshade fixing piece. A power supply circuit is disposed on an inner side of the lampshade substrate. The cold light filaments are disposed on the lampshade substrate, and the cold light filaments are attached to the lampshade substrate based on a preset pattern and are electrically connected to the power supply circuit. The lampshade fixing piece is configured to fixedly shape the lampshade substrate and fix the lampshade substrate to the lamp body. After the cold light filaments on the lampshade are powered on, the cold light filaments emit light to display the preset pattern, which ensures that design sense of the preset pattern of the lampshade is displayed under low-light conditions.

### TECHNICAL FIELD

The present disclosure relates to a technical field of illumination, and in particular to a lampshade and a lamp.

### BACKGROUND

A lamp with a lampshade is a common fixture for illumination, for example for near-distance illumination in a bedroom or a living room.

Taking a table lamp as an example, the table lamp generally includes a lamp body and a lampshade. Since the table lamp is usually placed at a conspicuous position, certain decoration for the table lamp is necessary which is generally, to design some beautiful patterns on the lampshade. However, in a case of low-brightness illumination or low-light condition, the beautiful patterns cannot appear, which affects decorative effect of the patterns.

### SUMMARY

The present disclosure provides a lampshade and a lamp, aiming to solve above existing technical problems.

The lampshade of the present disclosure includes a lampshade substrate, cold light filaments, an external wiring, and a lampshade fixing piece. A power supply circuit is disposed on an inner side of the lampshade substrate. The cold light filaments are disposed on the lampshade substrate, and the cold light filaments are attached to the lampshade substrate based on a preset pattern and are electrically connected to the power supply circuit. The external wiring is attached to the power supply circuit to realize electrical connection, and the external wiring is led out to be electrically connected to a circuit assembly in a lamp body. The lampshade fixing piece is configured to fixedly shape the lampshade substrate and fix the lampshade substrate to the lamp body.

Optionally, the power supply circuit is disposed on an outer periphery of the lampshade substrate.

Optionally, the lampshade fixing piece is in a support structure, and the support structure is fixed to a base of the lamp body to achieve mounting of the lampshade.

Optionally, the power supply circuit is electrically connected to the circuit assembly in the lamp body through the support structure.

Optionally, the cold light filaments are a continuous segment or discontinuous multiple segments, and each of the multiple segments of the cold light filaments is separately connected to the power supply circuit.

The present disclosure further provides a lamp, including a lamp body and a lampshade. The lampshade includes a lampshade substrate, cold light filaments, an external wiring, and a lampshade fixing piece. A power supply circuit is disposed on an inner side of the lampshade substrate. The cold light filaments are disposed on the lampshade substrate, and the cold light filaments are attached to the lampshade substrate based on a preset pattern and are electrically connected to the power supply circuit. The external wiring is attached to the power supply circuit to realize electrical connection, and the external wiring is led out to be electrically connected to a circuit assembly in a lamp body. The lampshade fixing piece is configured to fixedly shape the lampshade substrate and fix the lampshade substrate to the lamp body.

Optionally, the power supply circuit is disposed on an outer periphery of the lampshade substrate.

Optionally, the lampshade fixing piece is in a support structure, and the support structure is fixed to a base of the lamp body to achieve mounting of the lampshade.

Optionally, the power supply circuit is routed through the support structure and is electrically connected to the circuit components in the lamp body.

Optionally, the cold light filaments are a continuous segment or discontinuous multiple segments, and each of the multiple segments of the cold light filaments is separately connected to the power supply circuit.

Beneficial effects achieved by the present disclosure are as follows: the power supply circuit is disposed on the lampshade, the cold light filaments are attached to the lampshade, and the cold light filaments are attached based on the preset pattern. After the cold light filaments on the lampshade are powered on, the cold light filaments emit light so that the present pattern is displayed, which ensures that design sense of the preset pattern of the lampshade is displayed under low-light conditions.

### BRIEF DESCRIPTION OF DRAWINGS

FIG. 1 is a structural schematic diagram of a lampshade of the present disclosure where the lampshade is in an unfolding state.

FIG. 2 is a structural schematic diagram of a lamp of the present disclosure.

### DETAILED DESCRIPTION

In order to make objectives, technical solutions and advantages of the present disclosure clearer, the present disclosure is further described in detail below with reference to accompanying drawings and embodiments. It should be understood that the specific embodiments described herein are merely configured to explain the present disclosure, and are not intended to limit the present disclosure.

### Embodiment 1

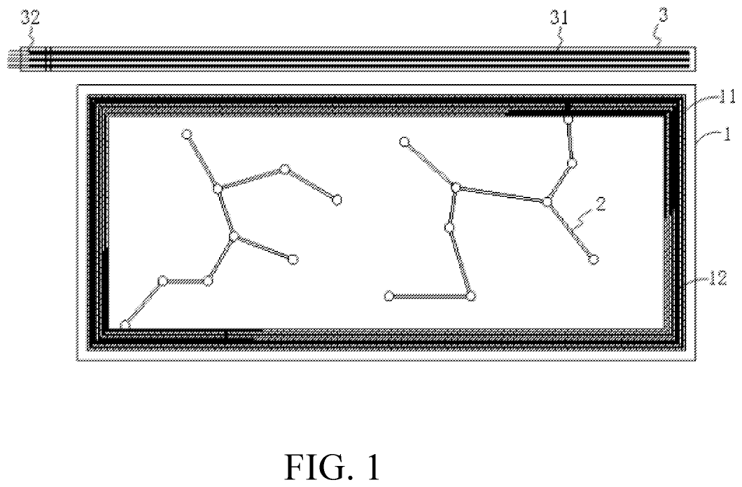

In the present embodiment, as shown in FIG. 1, the present disclosure provides a lampshade, including a lampshade substrate 1, cold light filaments 2, an external wiring 3, and a lampshade fixing piece (not shown in the drawings). A power supply circuit 11 is disposed on an inner side of the lampshade substrate 1. The cold light filaments 2 are disposed on the lampshade substrate 1, and the cold light filaments 2 are attached to the lampshade substrate 1 based on a preset pattern and are electrically connected to the power supply circuit 11. The external wiring 3 is attached to the power supply circuit 11 to realize electrical connection, and the external wiring 3 is led out to be electrically connected to a circuit assembly in a lamp body. The lampshade fixing piece is configured to fixedly shape the lampshade substrate 1 and fix the lampshade substrate 1 to the lamp body.

The preset pattern formed by the cold light filaments 2 shown in FIG. 1 is merely an exemplary pattern provided by the present embodiment. According to different requirements, the cold light filaments 2 may be configured to design and form patterns such as scenery, human faces, animals, buildings, etc., or a combination of multiple patterns.

In the present embodiment, as a specific embodiment, the power supply circuit 11 is disposed on an outer periphery of the lampshade substrate 1, so as to be electrically connected to the cold light filaments 2. In general, the lampshade substrate 1 has a certain light transmittance, and the pattern is displayed through light.

In the present embodiment, the lampshade fixing piece is in a support structure (not shown in the drawings, similar to a cross-shaped support structure or other similar structure), and the lampshade fixing piece may fix the lampshade substrate 1 which is rolled and shaped. The lampshade substrate 1 may be fixedly connected to the support structure through screws or other fastening means, and the support structure may further be connected to the lamp body (such as a lamp holder or a lamp post) of a lamp. The external wiring 3 may be routed through an internal or a surface of the support structure to be connected to the circuit assembly in the lamp body, so as to realize electrical connection and control of the cold light filaments 2 on the lampshade. An electrical connection circuit 31 is disposed in the external wiring 3, a connection terminal 32 is disposed on an end of the external wiring 3, and the electrical connection circuit 31 is electrically connected to an external power supply through the connection terminal 32. Meanwhile, the external wiring 3 is attached to the lampshade substrate 1 to electrically connect the electrical connection circuit 31 with the power supply circuit 11. Specifically, the electric connection between the electrical connection circuit 31 and the power supply circuit 11 is achieved through via or contacting with other exposed wire.

In the present embodiment, the cold light filaments 2 are a continuous segment or discontinuous multiple segments, and each of the multiple segments of the cold light filaments 2 is separately connected to the power supply circuit.

In the present embodiment, the power supply circuit is disposed on the lampshade, the cold light filaments are attached to the lampshade, and the cold light filaments are attached based on the preset pattern. After the cold light filaments on the lampshade are powered on, the cold light filaments emit light so that the present pattern is displayed, which ensures that decorations of the lampshade is displayed under low-light conditions.

### Embodiment 2

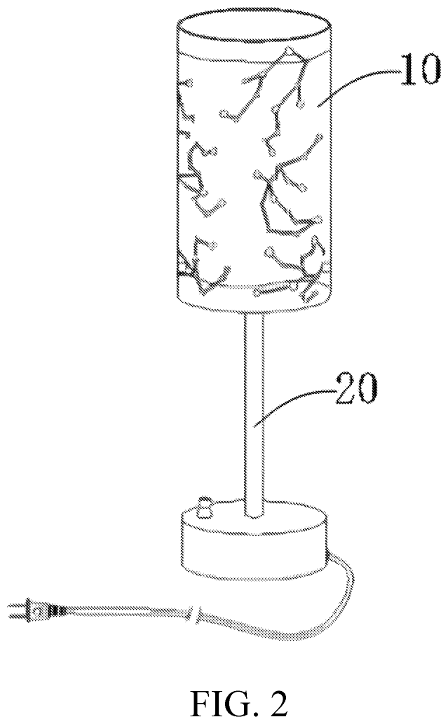

As shown in FIG. 2, in conjunction with FIG. 1, the present embodiment further provides a lamp, including a lamp body 20 and a lampshade 10. The lampshade includes a lampshade substrate 1, cold light filaments 2, an external wiring 3, and a lampshade fixing piece (not shown in the drawings). A power supply circuit 11 is disposed on an inner side of the lampshade substrate 1. The cold light filaments 2 are disposed on the lampshade substrate 1, and the cold light filaments 2 are attached to the lampshade substrate 1 based on a preset pattern and are electrically connected to the power supply circuit 11. The external wiring 3 is attached to the power supply circuit 11 to realize electrical connection, and the external wiring 3 is led out to be electrically connected to a circuit assembly in a lamp body. The lampshade fixing piece is configured to fixedly shape the lampshade substrate 1 and fix the lampshade substrate 1 to the lamp body 20.

In the present embodiment, as a specific embodiment, the power supply circuit 11 is disposed on an outer periphery of the lampshade substrate 1, so as to be electrically connected to the cold light filaments 2. In general, the lampshade substrate 1 has a certain light transmittance, and the pattern is displayed through light.

In the present embodiment, the lampshade fixing piece is in a support structure (not shown in the drawings, similar to a cross-shaped support structure or other similar structure), and the lampshade fixing piece may fix the lampshade substrate 1 which is rolled and shaped. The lampshade substrate 1 may be fixedly connected to the support structure through screws or other fastening means, and the support structure may further be connected to the lamp body (such as a lamp holder or a lamp post) of a lamp. The external wiring 3 is routed through an internal or a surface of the support structure to be connected to the circuit assembly in the lamp body, so as to realize electrical connection and control of the cold light filaments 2 on the lampshade. An electrical connection circuit 31 is disposed in the external wiring 3, a connection terminal 32 is disposed on an end of the external wiring 3, and the electrical connection circuit 31 is electrically connected to an external power supply through the connection terminal 32. Meanwhile, the external wiring 3 is attached to the lampshade substrate 1 to electrically connect the electrical connection circuit 31 with the power supply circuit 11. Specifically, the electric connection between the electrical connection circuit 31 and the power supply circuit 11 is achieved through via or contacting with other exposed wire.

In the present embodiment, the cold light filaments 2 are a continuous segment or discontinuous multiple segments, and each of the multiple segments of the cold light filaments 2 is separately connected to the power supply circuit.

Above descriptions are only the preferred embodiments of the present disclosure and are not intended to limit the present disclosure. Any modifications, equivalent replacements and improvements made within spirit and principles of the present disclosure should be included in a protection scope of the present disclosure.

What is claimed is:

1. A lampshade, comprising:
a lampshade substrate;
cold light filaments;
an external wiring; and
a lampshade fixing piece;
where a power supply circuit is disposed on an inner side of the lampshade substrate; the cold light filaments are disposed on the lampshade substrate, the cold light filaments are attached to the lampshade substrate based on a preset pattern and are electrically connected to the power supply circuit; the external wiring is attached to the power supply circuit to realize electrical connection, the external wiring is led out to be electrically connected to a circuit assembly in a lamp body; and the lampshade fixing piece is configured to fixedly shape the lampshade substrate and fix the lampshade substrate to the lamp body.

2. The lampshade according to claim 1, wherein the power supply circuit is disposed on an outer periphery of the lampshade substrate.

3. The lampshade according to claim 2, wherein the lampshade fixing piece is in a support structure, and the support structure is fixed to a base of the lamp body to achieve mounting of the lampshade.

4. The lampshade according to claim 1, wherein the power supply circuit is routed through the support structure and is electrically connected to the circuit assembly in the lamp body.

5. The lampshade according to claim 1, wherein the cold light filaments are a continuous segment or discontinuous multiple segments; each of the multiple segments of the cold light filaments is separately connected to the power supply circuit.

6. A lamp, comprising a lamp body and a lampshade;
wherein the lampshade comprises:
a lampshade substrate;
cold light filaments;
an external wiring; and
a lampshade fixing piece;
wherein a power supply circuit is disposed on an inner side of the lampshade substrate; the cold light filaments are disposed on the lampshade substrate, the cold light filaments are attached to the lampshade substrate based on a preset pattern and are electrically connected to the power supply circuit; the external wiring is attached to the power supply circuit to realize electrical connection, the external wiring is led out to be electrically connected to a circuit assembly in a lamp body; and the lampshade fixing piece is configured to fixedly shape the lampshade substrate and fix the lampshade substrate to the lamp body.

7. The lamp according to claim 6, wherein the power supply circuit is disposed on an outer periphery of the lampshade substrate.

8. The lamp according to claim 7, wherein the lampshade fixing piece is in a support structure, and the support structure is fixed to a base of the lamp body to achieve mounting of the lampshade.

9. The lamp according to claim 6, wherein the power supply circuit is routed through the support structure and is electrically connected to the circuit assembly in the lamp body.

10. The lamp according to claim 6, wherein the cold light filaments are a continuous segment or discontinuous multiple segments, wherein each of the multiple segments of the cold light filaments is separately connected to the power supply circuit.
